(19) United States
(12) Patent Application Publication
(10) Pub. No.: US 2022/0368069 A1
(43) Pub. Date: Nov. 17, 2022

(54) ELECTRIC INTERFACE

(71) Applicant: ELECTRON SQUARE SPÓLKA Z OGRANICZONA ODPOWIEDZIALNOSCIA, Poznan (PL)

(72) Inventors: Jakub BUSZYNSKI, Poznan (PL); Bartosz NOWICKI, Lochowo (PL)

(21) Appl. No.: 17/321,478

(22) Filed: May 16, 2021

(51) Int. Cl. H01R 13/62; G06F 1/18; G06F 1/16; H01R 13/24

(52) U.S. Cl. CPC H01R 13/6205; G06F 1/18; G06F 1/1633; H01R 13/24

(57) ABSTRACT

An electric interface comprising a motherboard (100) containing at least two interface receptacles (101) located on the motherboard (100) and at least one module (200) with the interface plugs (203). Each of the interface receptacles (101) includes at least one ground line contact (GND) at least one power line contact (VCC), at least two signal line contacts (SIG1, SIG2). All ground line contacts (GND) are connected to each other. All power line contacts (VCC) are connected to each other. All contacts of the first signal line (SIG1) are connected to each other. All contacts of the second signal line (SIG2) are connected to each other. Each module (200) contains a microcontroller (201) and an unit (202). The microcontroller (201) is connected to at least four module lines (PROBE1, PROBE2, PROBE3, PROBE4).

### TECHNICAL FIELD

The subject of the disclosure is an electric interface with power supply and communication.

### BACKGROUND

An electric interface containing an electrical plug and receptacle relying on magnetic force to maintain contact is known from U.S. Pat. No. 7,311,526B2. The plug and the receptacle are used as part of a power adapter for connecting an electronic device, such as a laptop computer, to a power supply. The plug includes electrical contacts, which are preferably biased toward corresponding contacts on the receptacle. The plug and receptacle each have a magnetic element. The magnetic element on one or both sides of the plug can be a magnet or electromagnet. The magnetic element in the receptacle is composed of ferromagnetic material. When the plug and receptacle are brought into proximity, the magnetic attraction between the magnet and the ferromagnetic material maintains the contacts in an electrically conductive relationship. The interface has the property that the plug and the receptacle are symmetrical and may be mutually rotated 180 degrees while maintaining the functionality on the electrical level of the interface.

From U.S. Pat. No. 9,252,543B2, an electric interface containing a dual orientation connector assembly for mating with a mating connector in two directions is known, including: an insulative housing defining a side wall, a printed circuit board (PCB) received in the housing, a mating member soldered on the PCB, a cable extending from and end of the insulative housing and a magnetic component disposed in the insulative housing to provide a retaining force for retaining to the mating connector. The mating member includes a mounting portion received in the insulative housing, a mating portion extending out of the side wall of the insulative housing for mating with the mating connector and a number of terminals mounted in the mating portion. The mating portion includes a first surface and an opposite second surface. The first surface and the second surface have the same number of the terminals.

An interface of an electrical connector assembly including a first connector and a second connector is known from U.S. Pat. No. 9,419,377B2. The first connector includes a first terminal group and a first magnetic element around the first terminal group, the first terminal group defines a first central terminal and two first outer terminals located at both sides of the first central terminal. The second connector includes a second terminal group and a second magnetic element, the second terminal group defines a second central terminal, a second outer terminal and an elastic terminal located at both sides of the second central terminal. When the first connector is engaging with the second connector, the first and second magnetic elements are attached to each other, the first central terminal is contacting the second central terminal, the second outer terminal is contacting either of the first outer terminals and the elastic terminal is elastically abutting against the first magnetic element.

From U.S. Pat. No. 9,577,372B1, an interface is known, including a connector containing at least one power conductor configured to supply power to an electronic device, at least one ground conductor to supply a ground to the electronic device, at least one data conductor configured to carry data to or from the electronic device and one or more connector orientation conductors.

Moreover, the interface contains a first magnet on a first side of the connector and a second magnet on a second side of the connector. The connector may be reversible to be magnetically-connectable to a mating connector in a first orientation and in a second orientation that is 180 degrees from the first orientation.

The connector may be operative to carry data and power to and/or from the mating connector when connected to the mating connector in the first orientation or in the second orientation.

All the above mentioned interfaces are connectable in a first orientation and in a second orientation that is 180 degrees from the first orientation while maintaining the correct electrical functionalities of the interface.

It is therefore advisable to create an interface which would maintain the correct electrical properties when changing orientation in more than one plane.

### SUMMARY

The subject of the solution is an electric interface comprising a motherboard containing at least two interface receptacles located on the motherboard and at least one module with the interface plugs. Each of the interface receptacles includes at least one ground line contact, at least one power line contact, at least two signal line contacts. All ground line contacts are connected to each other. All power line contacts are connected to each other. All contacts of the first signal line are connected to each other. All contacts of the second signal line are connected to each other. Each module contains a microcontroller and an unit. The microcontroller is connected to at least four module lines. Each of the module lines is secured by two Schottky diodes in such a way that the first diode is clipped with an anode to the module ground and with a cathode to the module line, whereas the second diode is clipped with an anode to the module line and with a cathode to the module power supply. When the interface plug is connected to the interface receptacle, each of the module lines can alternatively function as a power line, a ground line, a first signal line or a second signal line, regardless of the way the interface plug is connected to the interface receptacle.

Preferably, the module lines comply with the 120 standard.

Preferably, the motherboard is a printed circuit board PCB and the connection of the contact of the interface receptacles is made inside the motherboard.

Preferably, the motherboard is a 2- or 4- or 6- or 8- or 10- or 12- or 14- or 16-layer PCB.

Preferably, the motherboard complies with the LEGO® standard.

Preferably, the module is located inside a LEGO® standard brick and the plugs of the interface of the module are connected both to the contacts on the top of the brick and to the bottom contacts on the bottom of the brick.

### Advantages of the Solution

The main advantage of the solution is the total invariance of the interface, i.e. the possibility of clipping the module to the motherboard in any angular configuration, in the case of a square-shaped module: +/−0, 90, 180, 270 degrees, regardless of whether the rotation of the module is clockwise or counterclockwise.

The solution makes it easier to prototype and create the consumer electronics for people unfamiliar with electronics in practice due to the fact that the invariance of the interface protects the end user against the incorrect connection, short circuit in the system and, consequently, the possibility of damaging the modules.

### BRIEF DESCRIPTION OF DRAWINGS

The subject of the disclosure has been shown in the embodiments in the drawing, in which:

FIG. 1 shows the motherboard according to the first embodiment of the solution;

FIG. 2 shows the pictorial diagram of the module compatible with the motherboard according to the first embodiment of the solution;

FIG. 3 shows the simplified electrical diagram of the module compatible with the motherboard according to the first embodiment of the solution;

FIG. 4 shows the electrical diagram of the connections of the interface of the module compatible with the motherboard according to the first embodiment of the solution;

FIG. 5 shows the pictorial diagram of the connection of the interface of the module compatible with the motherboard according to the first embodiment of the solution to the microcontroller included in this module;

FIG. 6 shows the perspective view of the module compatible with the motherboard according to the first embodiment of the solution;

FIG. 7 shows the motherboard with one module according to the first embodiment of the solution in the perspective view;

FIG. 8 shows the pictorial diagram of the motherboard with four modules according to the second embodiment of the solution;

FIG. 9 shows the perspective view of the performance of the solution according to the third embodiment;

FIG. 10 shows the front view of the performance of the solution according to the third embodiment;

FIG. 11 shows the top view of the performance of the solution according to the third embodiment.

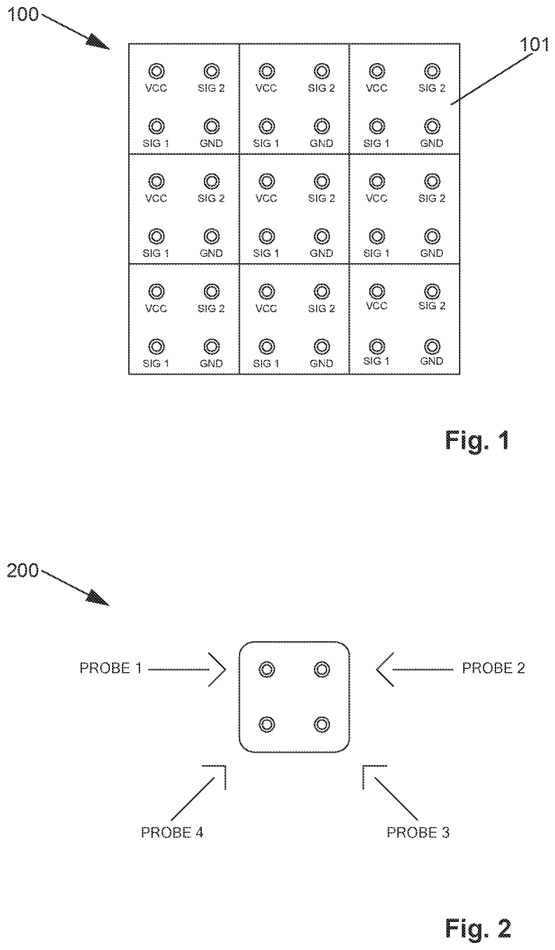

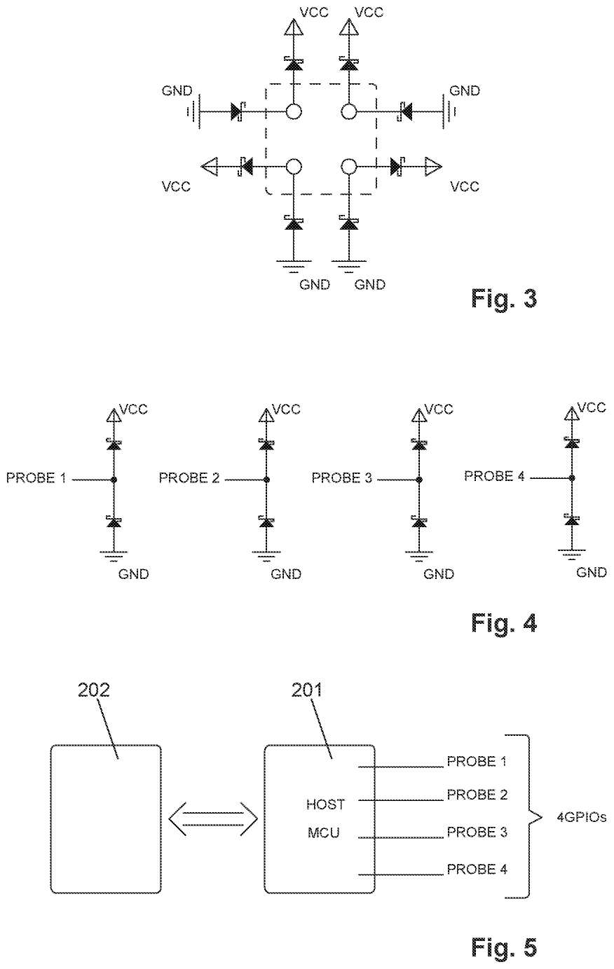

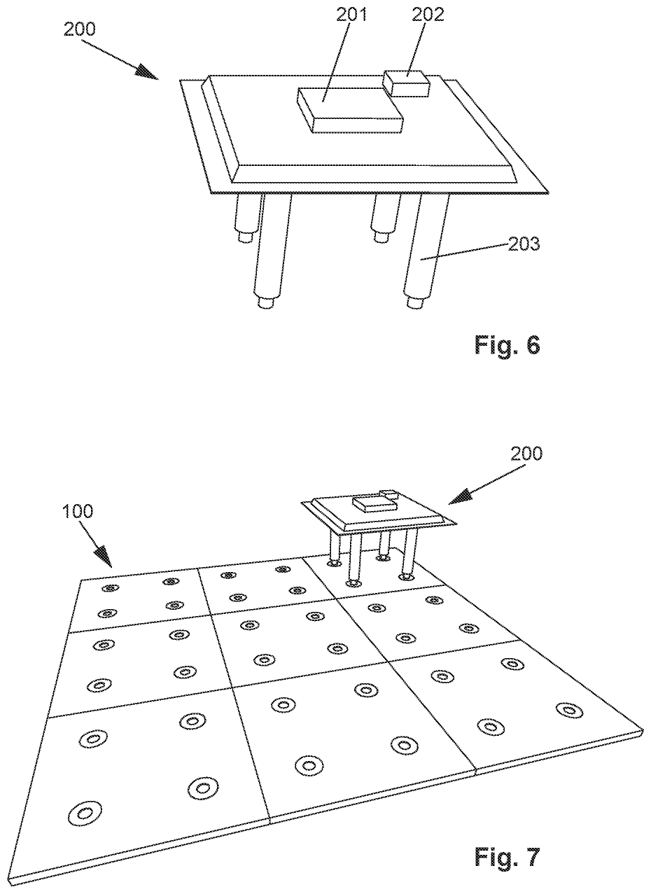

### DETAILED DESCRIPTION OF DISCLOSURE

### Embodiment 1

The motherboard 100 is a four-layer printed circuit board PCB, in which nine single interface receptacles 101 compatible with the plugs of the interface 203 of the modules 200 have been placed. Each of the receptacles contains a ground line GND contact in the lower right corner, a power line VCC contact in the upper left corner, a first signal line SIG1 contact in the lower left corner and a second signal line SIG2 contact in the upper right corner. Such placement of individual lines within single receptacle is a definition of the interface. Lines SIG1 and SIG2 have the function of the clock line and the data line alternatively. All ground line GND contacts are connected together inside the PCB. All power line VCC contacts are connected together inside the PCB. All first signal line SIG1 contacts are connected together inside the PCB. All second line SIG2 contacts are connected together inside the PCB. The connection of each type of contacts is made on a different PCB layer. VCC—layer 1, SIG1—layer 2, SIG2—layer 3, GND—layer 4.

The module 200 compatible with the receptacles 101 of the motherboard 100 contains a microcontroller 201 and an unit. The microcontroller is connected to the module lines PROBE1, PROBE2, PROBE3, PROBE4. Each of the module lines is secured by two Schottky diodes in a way presented in FIG. 4. Each of the module lines PROBE1, PROBE2, PROBE3, PROBE4 may have the function of the power line, ground line, first signal line or second signal line alternatively.

The interface allows any module 200 to be clipped into the motherboard 100 so that it is always properly powered and can communicate properly. The freedom lies in the fact that within the module lines PROBE1, PROBE2, PROBE3, PROBE4 of the module 200, each line can, without damaging of the module 200 and other modules clipped into the motherboard 200, perform the function of power supply, ground, first signal line or second signal line alternatively. Regardless of how the module is clipped, thanks to the use of high-speed Schottky diodes with low voltage drop, both positive and negative power supply terminals will be properly connected to the system. At the maximum load current (1 A), the voltage drop across the Schottky diode is a maximum of 620 mV, at 100 mA load current-290 mV. Assuming incorrect, from the point of view of the definition of the interface, connection of the module 200, such that line PROBE4 of the module 200 will be clipped to the VCC line of the motherboard 100, while line PROBE2 of the module 200 will be clipped to the GND line of the motherboard 100, the interface operation may be described as follows: The supply voltage (positive terminal VCC) from the motherboard 100 is applied through the line PROBE4 to the anode of the Schottky diode clipped by the cathode with the VCC line of the module. Due to the small voltage drop on the diode itself a local supply voltage VCC is created. At the same time, the opposing Schottky diode connected by the anode to the ground GND of the module and by the cathode to line PROBE4 prevents shorting the positive terminal VCC to the ground. Line PROBE2 is connected with the anode of the Schottky diode, the cathode of which is connected by the module 200 to the line VCC of the module. This will put the VCC voltage on this diode clipped by the anode to the ground GND by line PROBE2.

Description of the module configuration after clipping it to the motherboard.

The module 200 in the I2C protocol slave configuration, after being clipped to the motherboard 100, checks the logical state of the lines from PROBE1, PROBE2, PROBE3, PROBE4 for a time from 10 microseconds to 2 seconds. These lines are set by default as input lines. The microcontroller 201 of the module 200 checks for power lines and signal lines whether the state on the lines PROBE1, PROBE2, PROBE3, PROBE4 is low (logical 0) or high (logical 1). The negative power supply terminal is detected first as the low state is always read there, then, according to the definition of the interface, the positive power supply terminal, located diagonally, is determined. The other two lines are therefore signal lines due to the fact that they also have a default high state (pull-up). The microcontroller 201 of the module 200 checks by hardware interrupts whether the line in question is a clock line or a data line. After determining the type of all the lines, the system is ready for the operation.

The module 200 in the 120 protocol master configuration, after being clipped to the motherboard 100, checks the logical state of the lines from PROBE1, PROBE2, PROBE3, PROBE4 for a time from 10 microseconds to 2 seconds. These lines are set by default as input lines. The microcontroller 201 of the module 200 checks for power lines and signal lines whether the state on the lines PROBE1, PROBE2, PROBE3, PROBE4 is low (logical 0) or high (logical 1). The negative power supply terminal is detected first as the low state is always read there, then, according to the definition of the interface, the positive power supply terminal, located diagonally, is determined. The other two lines are therefore signal lines due to the fact that they also have a default high state (pull-up). The microcontroller 201 of the module 200 sets the two other lines as a clock line and a data line in order to be able to communicate with the modules 200 in the slave configuration.

### Embodiment 2

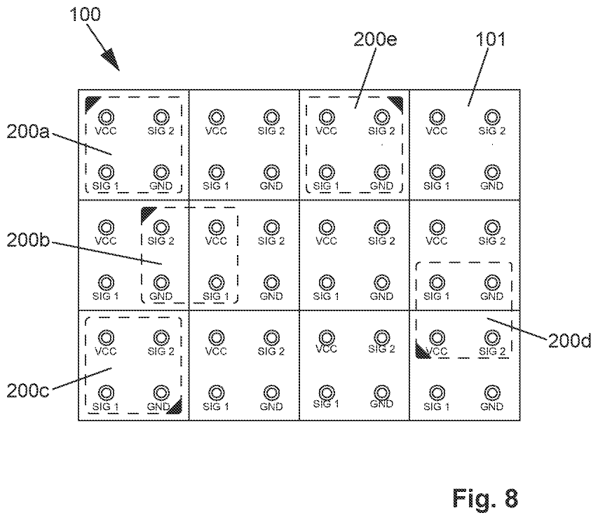

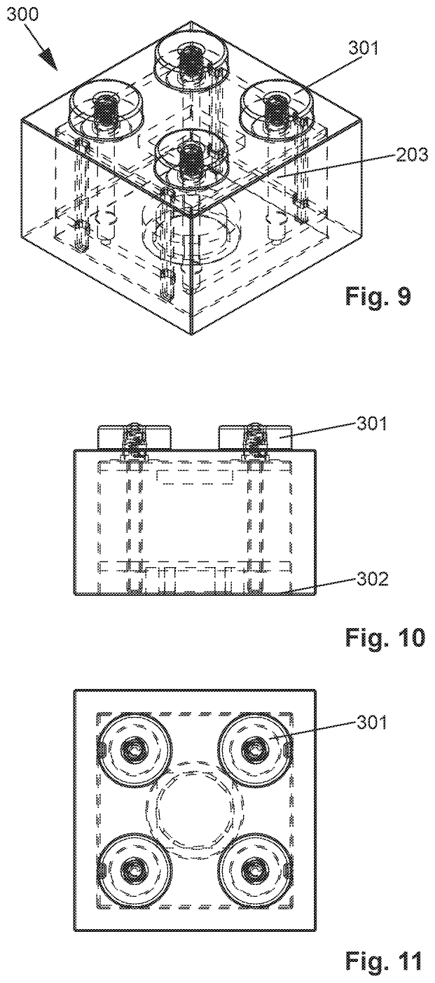

The motherboard 100 is a four-layer printed circuit board PCB, in which twelve single interface receptacles 101 compatible with the plugs of the interface 203 of the modules 200 have been placed (FIG. 8). Each of the receptacles contains a ground line GND contact in the lower right corner, a power line VCC contact in the upper left corner, a first signal line SIG1 contact in the lower left corner and a second signal line SIG2 contact in the upper right corner. Such placement of individual lines within single receptacle is a definition of the interface. Lines SIG1 and SIG2 have the function of the clock line and the data line alternatively. All ground line GND contacts are connected together inside the PCB. All power line VCC contacts are connected together inside the PCB. All first signal line SIG1 contacts are connected together inside the PCB. All second line SIG2 contacts are connected together inside the PCB. The connection of each type of contacts is made on a different PCB layer. VCC—layer 1, SIG1—layer 2, SIG2— layer 3, GND—layer 4.

The motherboard 100 is connected with five modules 200a, 200b, 200c, 200d, 200e. The modules are identical to the embodiment 1. The module 200a is clipped into the motherboard 100 in accordance with the definition of the interface, what has been indicated schematically by painting over the upper left corner. The module 200b is clipped into the motherboard 100 in such a way that is uses two adjacent interface receptacles 101 in the x-axis direction. The module 200c is clipped into the motherboard 100 in such a way that it has been rotated 180 degrees with respect to the line layout in accordance with the definition of the interface. The module 200d is clipped into the motherboard 100 in such a way that it has been rotated 270 degrees with respect to the line layout in accordance with the definition of the interface and uses two adjacent interface receptacles 101 in the y-axis direction. The module 200e is clipped into the motherboard 100 in such a way that it has been rotated 90 degrees with respect to the line layout in accordance with the definition of the interface.

The rule of the interface operation from the electrical point of view and the method of the module configuration is analogous to that in embodiment 1. Each of the modules 200a, 200b, 200c, 200d and 200e will therefore function properly.

### Embodiment 3

A single module 200 as in embodiment 1 has been placed inside a LEGO® standard brick (300) able to transfer the electrical signals. The interface plugs 203 of the module 200 located inside the brick 300 are connected both with the contacts 301 on the top of the brick and the bottom contacts 302 on the bottom of the brick. In this case, the motherboard is the brick analogous to the one from embodiment 1, but compliant with the LEGO® standard.

Other Properties of the Modules:

The unit 202 of the module 200 may include any integrated circuit together with the passive circuits, that is, any electronic circuit with any functionality compatible with the microcontroller. These can be, for example, LED diodes, buttons, radio circuits, GPS circuits, sensors and LCD screens. At the same time, there is a possibility to use other communication protocols than I2C.

Modules may also have more than 4 PROBE lines, there is also no need to place these lines on the plan of the square as in the embodiments. The shape can be any. A symmetrical shape of the modules is preferred, especially in the form of regular figures or oval.

1. An electric interface comprising a motherboard (100) containing at least two interface receptacles (101) located on the motherboard (100) and at least one module (200) with the interface plugs (203), wherein each of the interface receptacles (101) includes
at least one ground line contact (GND),
at least one power line contact (VCC),
at least two signal line contacts (SIG1, SIG2), and
all ground line contacts (GND) are connected to each other,
all power line contacts (VCC) are connected to each other,
all contacts of the first signal line (SIG1) are connected to each other,
all contacts of the second signal line (SIG2) are connected to each other, wherein
each module (200) contains a microcontroller (201),
and an unit (202) and
the microcontroller is connected to at least four module lines (PROBE1, PROBE2, PROBE3, PROBE4), wherein
each of the module lines is secured by two Schottky diodes in such a way that the first diode is clipped with an anode to the module ground and with a cathode to the module line, whereas
the second diode is clipped with an anode to the module line and with a cathode to the module power supply, wherein
each of the module lines PROBE1, PROBE2, PROBE3, PROBE4), when the interface plug (203) is connected to the interface receptacle (101), can alternatively function as a power line (VCC), a ground line (GND), a first signal line (SIG1) or a second signal line (SIG2), regardless of the way the interface plug (203) is connected to the interface receptacle (101).

2. The electric interface according to claim 1, wherein the module lines (200) comply with the I2C standard.

3. The electric interface according to claim 1, wherein the motherboard (100) is a printed circuit board PCB and the connection of the contacts of the interface receptacles is made inside the motherboard (100).

4. The electric interface according to claim 3, wherein the motherboard (100) is a 2- or 4- or 6- or 8- or 10- or 12- or 14- or 16-layer PCB.

5. The electric interface according to claim 1, wherein the motherboard (100) complies with the LEGO® standard.

6. The electric interface according to claim 5, wherein in that, the module (200) is located inside a LEGO® standard brick (300) and the plugs of the interface (203) of the module (200) are connected both to the contacts (301) on the top of the brick and to the bottom contacts (302) on the bottom of the brick.
